(19) United States
(12) Patent Application Publication
(10) Pub. No.: US 2003/0007542 A1
(43) Pub. Date: Jan. 9, 2003

(54) Thermogravimetric analyzer

(75) Inventors: John W. Peterman JR., Madison, WI (US); Ned Dallman, Middleton, WI (US)

Correspondence Address: MICHAEL BEST & FRIEDRICH, LLP, 100 E WISCONSIN AVENUE, MILWAUKEE, WI, 53202, US

(73) Assignee: Thermo Cahn Corporation, Madison, WI

(21) Appl. No.: 09/887,301

(22) Filed: Jun. 22, 2001

(51) Int. Cl. G01N 25/00

(52) U.S. Cl. 374/14

(57) ABSTRACT

A thermogravimetric analyzer comprising a base, a magnet secured to the base, a coil pivotally coupled to the base, a beam coupled to the coil such that the beam can pivot with the coil, a sample support supported by the beam, and a heat chamber substantially surrounding the sample support. The beam preferably comprises a material having at least 25% carbon by volume and a thermal expansion coefficient of less than 1×10-6/K and a thermal conductivity of at least 100 W/mK.

### FIELD OF THE INVENTION

This invention relates to thermogravimetric analyzers (TGAs), which are used by laboratories and testing facilities to measure weight change as a function of changing temperature.

### BACKGROUND OF THE INVENTION

TGAs are commonly used to monitor the change in mass of a sample as a result of changing temperature. TGAs typically include a heat chamber for heating the sample and a balance for weighing the sample. When very small samples are being monitored, a microbalance is sometimes used.

Microbalances are commonly used to weigh samples of less than one milligram, and some microbalances can do so to a precision of about 0.1 micrograms. A typical microbalance includes a balance beam having a central pivot point. One end of the beam is designed to support the sample, and the other end of the beam can be used to support a tare for counterbalancing larger loads. An electromagnet is commonly used to counterbalance the weight of the sample and provide a measurement of the sample weight.

Microbalances are commonly used to continuously monitor the mass of a sample as a function of some parameter, such as time, pressure, temperature, etc. Such microbalances are often referred to as recording microbalances. A recording microbalance typically includes sensors (e.g., photocells) that sense the position of the beam. If the sample changes in weight, the sensors will sense the corresponding movement of the beam. A microprocessor can then be used to automatically adjust the electromagnet current to move the beam back to the neutral position.

### SUMMARY OF THE INVENTION

When used on a TGA, the accuracy of many standard microbalances is greatly diminished due to the unstable thermal properties of the beam material. For example, some beam materials, such as quartz, have very low thermal conductivity, which can result in a beam having a large temperature gradient and a corresponding nonuniformity along its length. To counter this effect, some beams are made from materials having a high thermal conductivity, such as aluminum and stainless steel. However, these materials have high thermal expansion properties, which can result in a significant change in the length of the beam. This can result in a loss of accuracy of the microbalance.

The present invention alleviates the above-noted issues by providing a TGA with a microbalance beam that has little or no effect on the accuracy of the TGA's measurements under extreme thermal conditions. More specifically, the present invention provides a beam having a thermal expansion coefficient of less than 1×10-6/K (preferably about−0.5×10-6) and a thermal conductivity of at least 100 W/mK (preferably about 275 W/mK). In one embodiment, this is accomplished by making the beam from a material having at least 25% carbon by volume (preferably about 55-60% by volume). For example, the beam could be made from a carbon fiber-epoxy composite material. This composite material is lightweight and extremely stiff, both important factors when considering beam material.

In an alternate embodiment, the balance beam is molded from a carbon fiber-carbon material and coated with silicon carbide. This embodiment contains both desirable thermal properties noted above, and maintains microbalance measurement accuracy at temperatures exceeding 1100° C.

### BRIEF DESCRIPTION OF THE DRAWINGS

FIG. 1 is a section view of a thermogravimetric analyzer

FIG. 2 is a perspective view of a microbalance containing a balance beam embodying the present invention

FIG. 3 is a perspective view of an alternate embodiment of a microbalance and balance beam.

### DETAILED DESCRIPTION

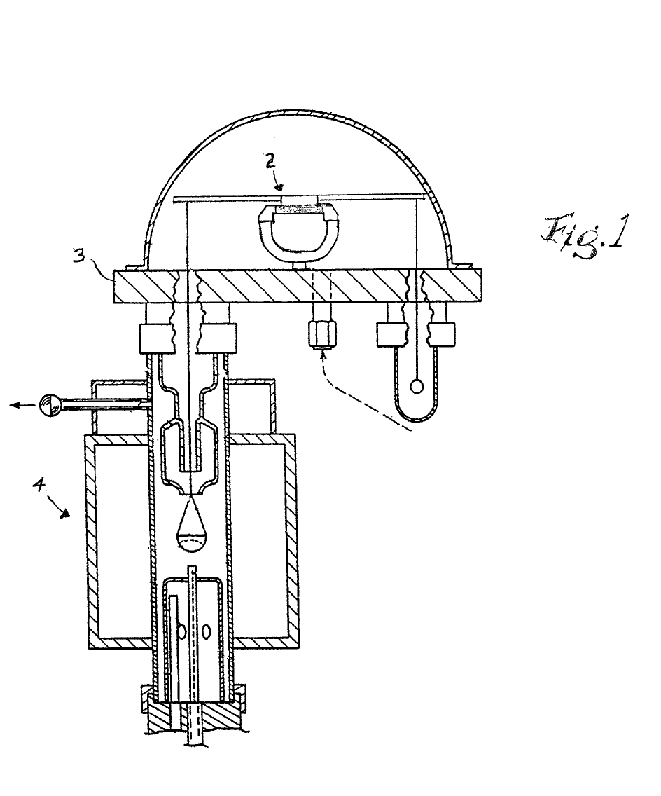

With reference to FIG. 1, a thermogravimetric analyzer (TGA) assembly is illustrated generally including a microbalance assembly 2, a base 3, and a heating assembly 4. Details of the illustrated TGA can be found in U.S. Pat. No. 5,055,264, which is hereby incorporated by reference.

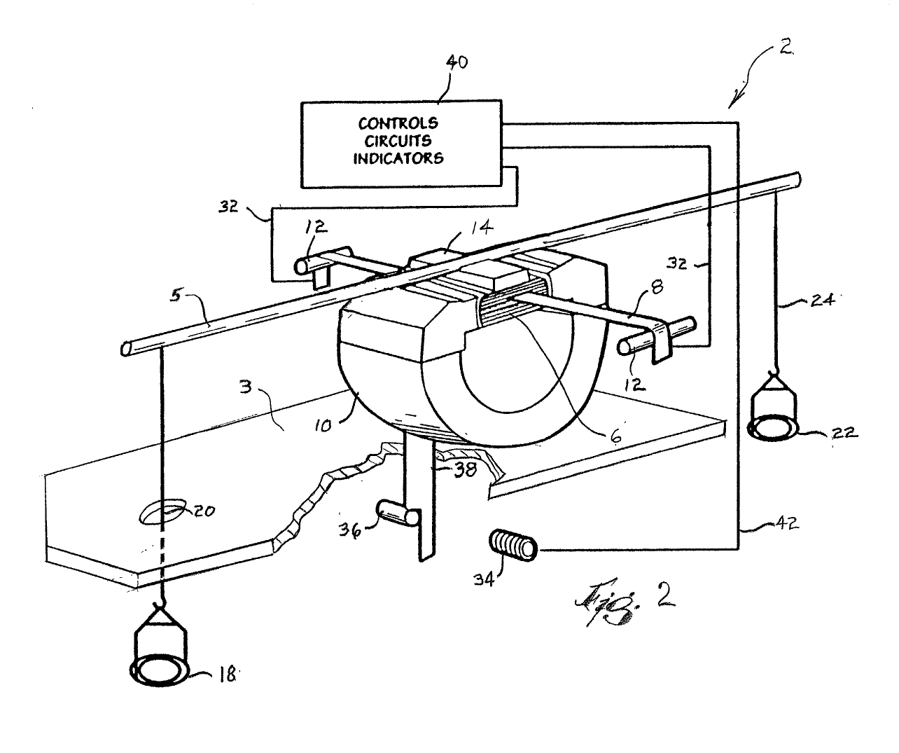

The microbalance assembly 2 is illustrated in more detail in FIG. 2. The illustrated microbalance assembly 2 generally includes a beam 5, a coil 6, a pivoting ribbon 8, and a magnet 10. The ribbon 8 is stretched between two bobbins 12 to provide a pivoting suspension. The coil 6 is secured to the ribbon 8, and the beam 4 is mounted to a support pad 14 on the coil 6. The coil defines a pivot member that, along with the beam, can pivot due to the torsional flexibility of the ribbon 8. This type of design is standard in the microbalance field. It should be appreciated that, instead of a static magnet and a pivoting coil, the invention could also be embodied in a microbalance having a static coil and a pivoting magnet.

A sample support in the form of a conventional sample plate 18 is suspended by means of a hang down 20 to the end of the balance beam 4 and is used for receiving a sample to be weighed. In the illustrated embodiment, the hang down 20 extends through an opening in the base 3. A corresponding tare plate 22 is suspended by means of a hang down 24 to the other end of the balance beam 4. Although not illustrated, the hang down 24 can also extend through an opening in the base 3. It should be appreciated that this embodiment is not meant to be limiting and that other methods of holding samples are applicable to balances other than ones with hang downs, such as top loading balances and balances without hangdowns.

The magnet 10 is secured to the base 3 on the assembly. The magnet 10 provides a static magnetic field. Two electrical wires 32 provide electrical current to the coil 6 via the ribbon 8 in order to create an adjustable electromagnetic field. The electromagnetic field interacts with the static magnetic field to provide a restoring force that can be used to restore the assembly to a substantially neutral horizontal position.

The assembly further includes a photodiode 36 coupled to the base 3, a photo detector 34 coupled to the base 3, a flag 38 coupled to the pivoting beam 4, and a control circuit 40. The flag 38 extends in a downward direction from the pivoting assembly and will pivot with the beam 4. The flag will block communication between the photodiode 36 and the photo detector 34 when the beam 4 is in a substantially neutral horizontal position. Upon rotation of the beam 4 and the initialization of communication between the photodiode 36 and photo detector 34, the photo detector 34 relays a message to the control circuit 40 by means of a wire 42. The controlling circuit 40 will then prompt the microbalance assembly 2 to adjust for the rotation by increasing or decreasing the current provided to the coil, thus restoring the microbalance assembly 2 to a substantially neutral horizontal position. The microbalance assembly 2 will cease to correct for rotation when the flag 38 once again interrupts the communication between the photodiode 36 and the photo detector 34. It should be appreciated that the above-described flag 38, photodiode 36, and photo detector 34 provide one way of monitoring the position of the beam and providing feedback to the control circuit 40. Other systems could be used to perform this function. It should also be appreciated that multiple photo detectors may be used for receiving signals from a photodiode or multiple photodiodes.

In the preferred embodiment, the beam 4 is molded from a graphite or carbon fiber material coated with an epoxy resin matrix. The illustrated beam 4 is two (2) millimeters in diameter, and the material can be purchased from Goodfellow Corporation of Berwyn, Pa. under part number C427905. This material provides a part that is about 55-60% carbon fiber by volume and about 40-45% epoxy by volume. In comparison to the prior art materials commonly used for microbalance beams, the preferred material has high thermal conductivity and low thermal expansion. Both of these properties are beneficial in heated environments.

| | thermal expansion coefficient | thermal conductivity |
|---|---|---|
| carbon fiber | −0.5 × 10-6 /K | 250-300 W/mK |
| epoxy rod | | |
| aluminum tubing | 23.5 × 10-6 | 237 W/mK |
| stainless steel | 15.3 × 10-6 | 16.7 W/mK |
| tubing | | |
| quartz rod | 0.54 × 10-6 | 1.46 W/mK |

Due to these properties, the beam will rapidly conduct heat throughout the entire beam, thus inhibiting hot points and warpage in the beam. In addition, the beam will resist expansion, thus maintaining the accuracy of the microbalance measurements.

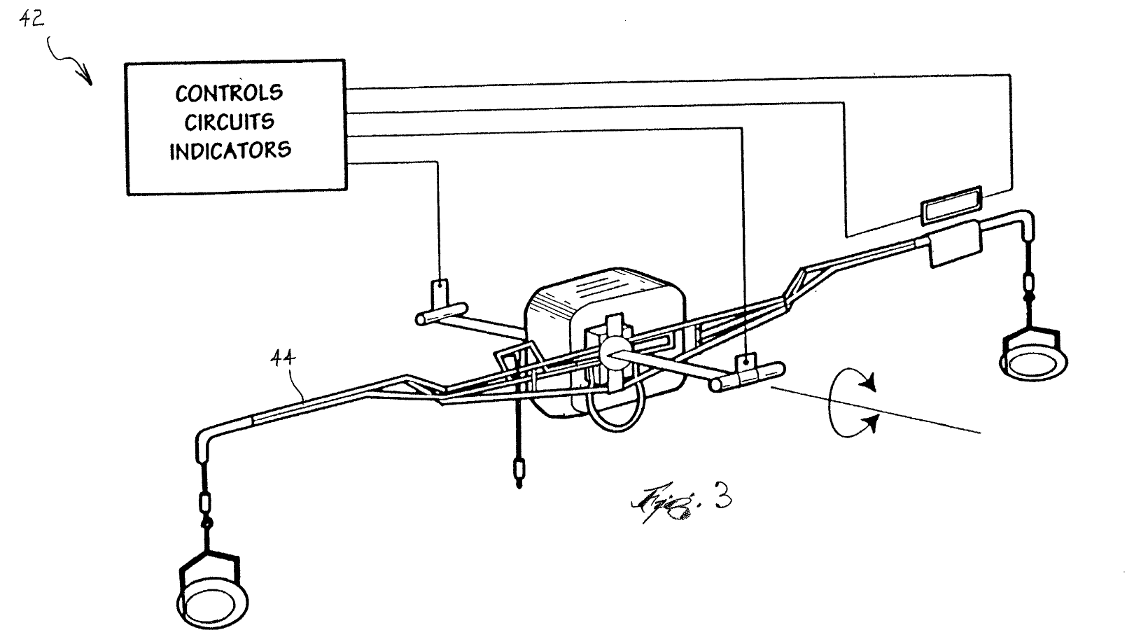

Referring to FIG. 3, an alternate embodiment of a microbalance 42 is shown. The microbalance 42 operates, for the most part, the same way that the microbalance 2 operates in FIG. 2. The microbalance 42 is referred to because it utilizes a different style of beam. The beam 44, like the beam 4 in FIG. 2, can be molded from a graphite or carbon fiber material coated with an epoxy resin matrix. This goes to show that the graphite or carbon fiber material coated with an epoxy resin matrix can be utilized in almost any balance beam on almost any microbalance.

In summary, microbalance beams molded out of graphite or carbon fiber material coated with an epoxy resin matrix contain both desirable thermal properties of low thermal expansion and high thermal conductivity. By having both desirable properties, the life of the balance beam and accuracy of the measurements will increase in high temperature applications over materials such as quartz, aluminum, or stainless steel.

In an alternative embodiment, the beam can be made from a carbon-carbon matrix material. This design would be beneficial in a high temperature environment where the epoxy material of the preferred embodiment might not hold up. As an enhancement to this embodiment, the material could be coated with silicon carbide to further enhance the high-temperature capabilities.

The foregoing description of the present invention has been presented for purposes of illustration and description; furthermore, the description is not intended to limit the invention to the form disclosed herein. Consequently, variations and modifications commensurate with the above teachings, and the skill or knowledge of the relevant art, are within the scope of the present invention. The embodiments described herein are further intended to explain best modes known for practicing the invention and to enable others skilled in the art to utilize the invention in such, or other, embodiments and with various modifications required by the particular applications or uses of the present invention. It is intended that the appended claims be construed to include alternative embodiments to the extent permitted by the prior art.

What is claimed is:

1. A thermogravimetric analyzer comprising:
a base;
a magnet coupled to the base;
a coil coupled to the base, wherein at least one of the magnet or the coil defines a pivot member that is pivotally coupled to the base;
a beam coupled to the pivot member such that the beam can pivot with the pivot member, the beam comprising a material having at least 25% carbon by volume;
a sample support supported by the beam; and
a heat chamber substantially surrounding the sample support.

2. A thermogravimetric analyzer as claimed in claim 1, wherein the magnet is secured to the base and the coil is pivotally coupled to the base.

3. A thermogravimetric analyzer as claimed in claim 2, wherein the beam is secured to the coil.

4. A thermogravimetric analyzer as claimed in claim 1, wherein the beam comprises a material having at least 50% carbon by volume.

5. A thermogravimetric analyzer as claimed in claim 1, wherein the beam comprises a material having at least 50% carbon fiber by volume.

6. A thermogravimetric analyzer as claimed in claim 1, wherein the beam comprises a material having at least 25% epoxy by volume.

7. A thermogravimetric analyzer as claimed in claim 1, wherein the beam comprises a material having about 40-70% carbon by volume.

8. A microbalance comprising:
a base;
a magnet coupled to the base;
a coil coupled to the base, wherein at least one of the magnet or the coil defines a pivot member that is pivotally coupled to the base; and
a beam coupled to the pivot member such that the beam can pivot with the pivot member, the beam comprising a material having at least 25% carbon by volume.

9. A microbalance as claimed in claim 8, wherein the magnet is secured to the base and the coil is pivotally coupled to the base.

10. A microbalance as claimed in claim 9, wherein the beam is secured to the coil.

11. A microbalance as claimed in claim 8, wherein the beam comprises a material having at least 50% carbon by volume.

12. A microbalance as claimed in claim 8, wherein the beam comprises a material having least 50% carbon fiber by volume.

13. A microbalance as claimed in claim 8, wherein the beam comprises a material having at least 25% epoxy by volume.

14. A microbalance as claimed in claim 8, wherein the beam comprises a material having about 40-70% carbon by volume.

15. A microbalance comprising:
a base;
a magnet coupled to the base;
a coil coupled to the base, wherein at least one of the magnet or the coil defines a pivot member that is pivotally coupled to the base; and
a beam coupled to the pivot member such that the beam can pivot with the pivot member, the beam having a thermal expansion coefficient of less than 1×10-6 /K and a thermal conductivity of at least 100 W/mK.

16. A microbalance as claimed in claim 15, wherein the magnet is secured to the base and the coil is pivotally coupled to the base.

17. A microbalance as claimed in claim 16, wherein the beam is secured to the coil.

18. A microbalance as claimed in claim 15, wherein the beam has a thermal expansion coefficient of less than 0 and a thermal conductivity of at least 200 W/mK.

19. A microbalance as claimed in claim 15, wherein the beam has a thermal expansion coefficient of about −0.5×10-6 and a thermal conductivity of about 275 W/mK

20. A microbalance as claimed in claim 15, wherein the beam comprises a carbon fiber—epoxy composite.

21. A microbalance as claimed in claim 15, wherein the beam comprises silicon carbide.

22. A method of assembling and using a microbalance, comprising:
providing a base;
coupling a magnet to the base;
coupling a coil to the base, wherein at least one of the magnet or the coil defines a pivot member that is pivotally coupled to the base;
attaching a beam to the pivot member, the beam having a length;
increasing the temperature of the beam by 1 K; and
shortening the length of the beam as a result of the increasing step.

23. A method of assembling a microbalance as claimed in claim 22, wherein the shortening step comprises shortening the length of the beam by about 0.5×10-6 of the length as a result of the increasing step.

24. A method of assembling a microbalance as claimed in claim 22, further comprising dissipating heat through the beam at a rate of at least 250 W/mK as a result of the increasing step.
